(19) United States
(12) Patent Application Publication
(10) Pub. No.: US 2018/0032127 A1
(43) Pub. Date: Feb. 1, 2018

(54) APPARATUS AND METHOD FOR CENTRALLY MANAGING HUMAN INTERFACE SENSORS AND ACTUATORS IN INTERACTIVE MACHINES

(71) Applicant: H PLUS TECHNOLOGIES LTD., Vancouver (CA)

(72) Inventor: Dhruv Adhia, Vancouver (CA)

(73) Assignee: H Plus Technologies Ltd., Vancouver, BC (CA)

(21) Appl. No.: 15/533,937

(22) PCT Filed: Dec. 8, 2015
(86) PCT No.: PCT/CA2015/051286

§ 371 Date: Jun. 7, 2017

Related U.S. Application Data
(60) Provisional application No. 62/089,019, filed on Dec. 8, 2014.

(51) Int. Cl. G06F 3/01; G06T 17/00; G05B 19/409

(52) U.S. Cl. CPC G06F 3/011; G05B 19/409; G06T 17/005; G05B 2219/41146

(57) ABSTRACT

A computer programmed method and apparatus is provided for centrally managing sensors and actuators used by a human interactive machine, such as an interactive virtual hologram display machine. The method can be expressed as program code (“middleware implementation”) stored on a memory of the human interactive machine, and executed by a processor of that machine. The middleware implementation is created using a human interface sensor middleware platform, which acts as an intermediary between sensors in the human interactive machine that provide sensor data, such as accelerometers and motion capture cameras, and actuators in the human interactive machine such as projectors and sound systems. The middleware platform provides mechanisms for reporting and interrogating the protocols used by the sensors and actuators, as well as a standard architecture for creating services used in the middleware implementation.

### FIELD

This invention relates generally to a method and an apparatus for providing centralized management of sensors and actuators in an interactive machine, such as an interactive display machine.

### BACKGROUND

Conventionally programmed interactive machines require custom designed programs (often referred to as “middleware”) to manage data input from sensors and control instructions to actuators in the machines. Creating such programs can be onerous especially when there are a large number of sensors and actuators to control, or when different sensors and/or actuators are interchanged in the system.

Open source efforts exist which attempt to provide a common middleware programming platform. For example, YARP (for “Yet Another Robot Platform”) is an open source software package written in C++ for interconnecting sensors, processors and actuators in robots. YARP supports building a robot control system as a collection of programs communicating in a peer-to-peer manner, with an extensible family of connection types that can be swapped in and out to match a programmer's needs.

No known middleware programming platform including YARP exists to effectively control human interactive machines that use human interface sensors such as motion sensors, including acquisitioning raw data information and extracting feature data in real time from such sensors, nor to address challenges of managing human interactive machines that have multiple inputs and maintaining a low latency to avoid dropping display frame-rate and other reduced performance.

### SUMMARY

According to one aspect of the invention, there is provided a computer readable medium having encoded thereon a sensor middleware platform program executable by a processor to create a middleware implementation for controlling at least one sensor and at least one actuator in a human interactive machine. The middleware platform program comprises at least one input module, a middleware module, a filter module, and a reconstruction module. Each input module is configured to acquire raw data from a human interface sensor. The middleware module is configured to extract feature extracted data from the raw data, wherein the feature extracted data is relevant input data for controlling an operation of the human interactive machine by the middleware implementation. The filter module is configured to apply signal processing operations to the feature extracted data. The reconstruction module is configured to convert the filtered feature extracted data into a converted form accessible by a programmer to create the middleware implementation. The human interface sensor can be a motion capture camera, in which case the raw data can be a full body skeleton data and the feature extracted data is a portion of the full body skeleton data. The converted form of the portion of the skeleton data can be hierarchal data according to a selected 3D sensor protocol.

The input, middleware, filter and reconstruction modules can be program modules that interconnect using networking protocols based on a YARP programming platform (“YARP network”). The middleware platform program can further comprise at least one utility program communicative with at least one of the program modules via the YARP network; the utility program can comprise program code that is executable to monitor and control processes running in the at least one of the program modules. One type of utility program is a channel manager program which is communicative with the YARP network and executable to monitor services and connections between services in the at least one of the program modules, and to apply a set of YARP functions to the services. The channel manager program can comprise a view renderer which when executed renders a view of the services and connections of the at least one of the program modules, including an IP address, a port number, and a name of each service.

The middleware platform program can further comprise a registry service program that is communicative with other service programs in the program modules; the registry and comprises a registry database which stores information about the other service programs.

According to another aspect of the invention, there is provided a method for creating a middleware implementation for controlling at least one sensor and at least one actuator in a human interactive machine. The method comprises acquiring raw data from a human interface sensor of the human interactive machine; extracting feature extracted data from the raw data; applying signal processing operations to the feature extracted data; and converting the filtered feature extracted data into a converted form accessible by a programmer to create the middleware implementation.

The feature extracted data can be is passed through one or more buffers before the feature extracted data is filtered. A latency and correction check can performed on the feature extracted data while passing through the one or more buffers. Filtering the feature extracted data can comprises applying Kalman filtering to the feature extracted data. The step of converting the filtered feature extracted data can comprise checking off and parsing the filtered feature extracted data into checked-off data packages.

Data can be transported through the middleware implementation using networking protocols based on a YARP programming platform (“YARP network”), and the checked- off data packages can be stored in a YARP bottle and transported via the YARP network to at least one output module for performing the operation of the human interactive machine.

### BRIEF DESCRIPTION OF DRAWINGS

FIG. 1 is a perspective view of an a human-interactive virtual hologram display machine according to one embodiment.

FIGS. 2(a) and (b) show steps of a display program executed by a processor of the virtual hologram display machine to display a virtual 3D holographic image of an object onto a pyramidal display surface of the machine.

FIG. 3 is a schematic of virtual cameras used by the display program to capture 2D views of a 3D model of the object from four different perspectives.

FIG. 4 is a composite image of the captured 2D views that is projected by a projector of the virtual hologram display machine onto four surfaces of the pyramidal display to produce the virtual 3D holographic image.

FIG. 5 is a block diagram of components of the virtual hologram display machine shown in FIG. 1.

FIG. 6 is a block diagram of the structure of a centralized sensor and actuator management program (“middleware platform”) used to develop a middleware implementation for controlling sensors and actuators in the virtual hologram display machine.

FIG. 7 is a block diagram of the structure of a channel manager component of the middleware platform.

FIG. 8 is a view of middleware connections by a channel manager utility of the middleware platform.

FIG. 9 is graphical representation of an internal database structure used by a registration service of the middleware platform.

FIG. 10 is a flowchart of a process performed by a middleware platform for processing raw data acquired from a motion capture camera, and packaging this data for use by the middleware implementation.

### DETAILED DESCRIPTION

Overview

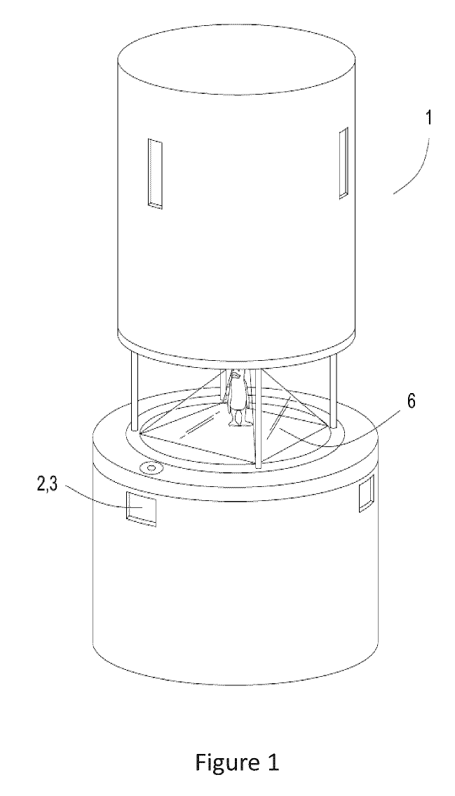

Embodiments of the invention described herein relate to a computer programmed method and apparatus for centrally managing sensors and actuators used by a human interactive machine, such as an interactive virtual hologram display machine (as shown in FIG. 1) which projects 2D images of an object onto a 3D display surface to create a virtual 3D hologram of the object, or an interactive playroom (not shown) that projects images of objects onto walls of the playroom. The method can be expressed as program code (herein referred to as “middleware implementation”) stored on a non-transitory computer readable medium such as a memory of the human interactive machine, and executed by a processor of that machine. The middleware implementation is created using a human interface sensor middleware platform which acts as an intermediary between sensors in the human interactive machine that provide sensor data, such as accelerometers and motion capture cameras, and actuators in the human interactive machine such as electronic displays and sound systems. The middleware platform provides mechanisms for reporting and interrogating the protocols used by the sensors and actuators, as well as a standard architecture for creating services used in the middleware implementation.

Generally speaking, the middleware platform comprises a plurality of program modules, namely: one or more input modules, a middleware module, a filter module, and a reconstruction module. Each input module collects relevant data from each sensor. The middleware module serves to extract and refine the collected sensor data. The filter module applies signal processing operations to the sensor data. The reconstruction module serves to convert the sensor data into a higher level machine readable form so that the data can be readily used by a programmer to develop the middleware implementation. The program modules interconnect using networking protocols based on the open source YARP platform, along with libraries that can be linked to applications to provide access to features offered by the middleware platform.

The middleware platform also includes other program modules which provide a user-friendly means for a programmer to develop and test different prototypes of a middleware implementation. These program modules comprise three main classes, namely: utilities services, and clients. Utilities are programs which provide access to the processes that are running in a middleware implementation, and allow the monitoring and management of such processes. Services are specifically designed applications that together define the functionality of the middleware implementation. Clients are programs that provide a formalized protocol to connect to the services.

The modularized structure of the middleware platform is expected to ease a programmer's task of programming the middleware implementation, by integrating and reading input drivers of various sensors and communicably connecting such drivers to displays and other actuators in the human interactive machine. More particularly, the modularized services provided by the middleware platform is expected to reduce the cumbersome task of setting up hardware devices and interacting with the software development kit (SDK) of each device, and allow a programmer to rapidly prototype middleware implementations having different configurations of sensors, actuators and functionalities.

Interactive Virtual Hologram Display Machine

In this embodiment, the middleware implementation will be described in the context of managing a motion-controlled virtual hologram display machine; however it is to be understood that the MS middleware platform can be used to create middleware implementations for other types of human interactive machines, such as an interactive playroom having motion and voice sensors and multiple projectors capable of displaying images on multiple walls, and controlling other functions of the playroom such as lighting.

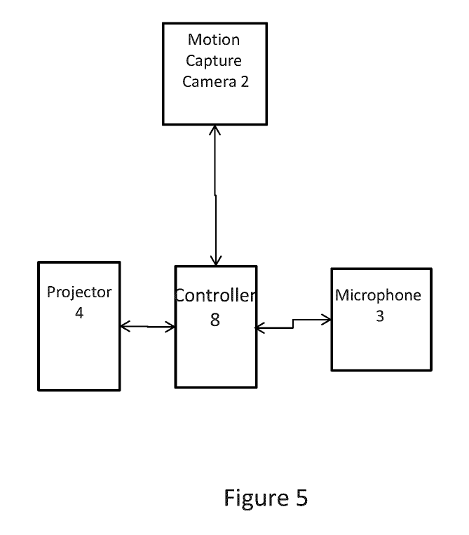

Referring to FIG. 1, a virtual hologram display machine 1 is shown, which comprises a motion capture camera 2, a microphone 3, a display projector 4, a pyramidal display structure 6 having four display surfaces, and a controller 8 (see FIG. 5) communicative with the camera 2, the microphone 3 and the projector 4. Commercially available motion capture devices such as the Microsoft Kinect™ and the Leap Motion Controller™ can be used as the camera 2 or camera/microphone combination. The display projector 4 can be any light projecting device, such as a lamp-based projector, or any electronic device with a light emitting display screen 5, such as a tablet computer or a smartphone. The controller 8 can be a general purpose computer, or a standalone controller such as a programmable logic controller (PLC).

The projector 4 is mounted in the machine 1 such that it is facing down towards the top end of the display structure 6. The display structure 6 comprises a front face, an opposed back face, and two opposed side faces (namely a left and right side face) extending between the front and back faces. Each face is tapered and narrower at its top end than at its bottom end. In the embodiment shown in FIG. 1, the left and right side faces of the display structure 6 are triangular and the front and back faces are trapezoidal and the display structure 6 has a rectangular base. The faces of the display structure 6 comprise a transparent or semi-transparent material, for example glass, polycarbonate glass, Plexiglas™, or other types of transparent or semi-transparent thermoplastics. A semi-transparent film may be laid on the faces of the display structure 6. The semi-transparent film or semi-transparent material of the faces may be chosen for its ability to allow partial passage of white light therethrough whilst some of the white light is absorbed which may enhance the brightness of an image displayed on the display structure 6. In some embodiments up to 95% of the white light projected onto the display structure 6 may be absorbed by the semi-transparent film or semi-transparent material. In one exemplary embodiment, the display structure 6 comprises coated polycarbonate glass with a refractivity between 28-35% and reflection rate between 65-72%.

Referring to FIG. 5, the controller 8 comprises a processor and a non-transitory memory; the memory has encoded thereon a middleware implementation program code executable by the processor to provide a user with services and utilities to manage the sensors and actuators of the machine 1, via one or more client modules. Although FIG. 5 shows the controller 8 coupled to the camera 2 and microphone 3 and projector 4, the controller 8 can also be coupled to other sensors and actuators that are not shown, such as a scanner, touchpad, light switch, and speakers.

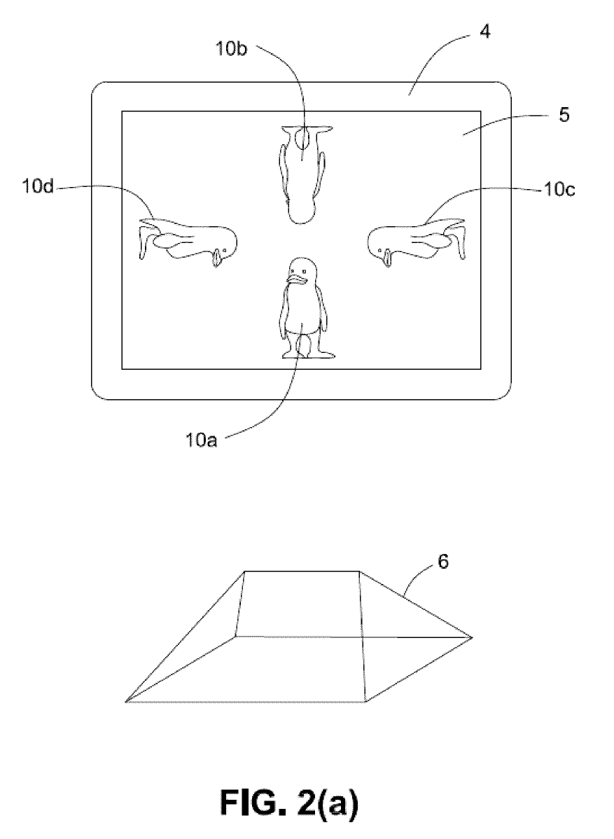

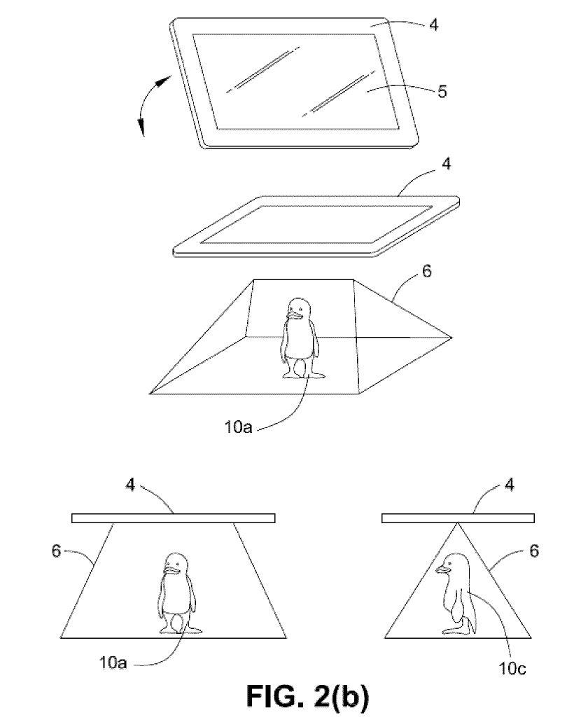

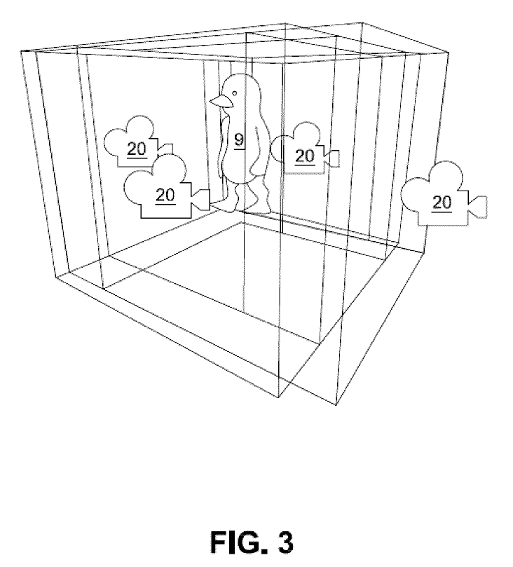

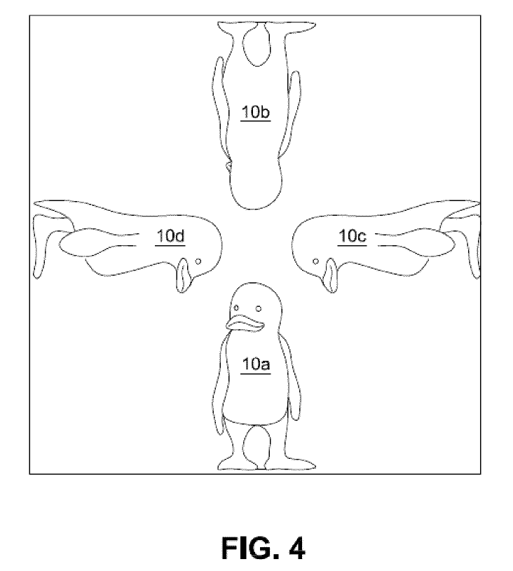

The controller 8 further comprises display program code executable by the processor to cause a digitized model of an object 9 stored in the memory to be projected onto the pyramidal display structure 6. FIGS. 2 to 4 show steps of a method that is performed by the processor when the display program is executed. Step one of the method involves rendering different 2D views of a 3D digitized model of the object 9 to produce a multi-view composite image 10 which is projected by the projector 104 onto surfaces of the pyramidal display structure 106 (“display pyramid”). More specifically, a 3D model of the object is rendered using 3D modeling software such as the Unity game engine, and virtual cameras 20 provided by the Unity game engine are positioned in front of, behind, and to the left and right of the 3D model to capture a front, rear, left side and right side view of the 3D model. In alternative embodiments, additional virtual cameras 20 may be used to provide additional views of the 3D model depending on the number of faces provided in the display structure onto which the multi-view composite image 10 is projected. A 3D rendering algorithm is used to produce a single 2D composite image 10 of these four views as shown in FIG. 4 (“multi-view image”). This multi-view image 10 comprises a front view 10a, rear view 10b, a left side view 10c and an opposed right side view 10d of the object 9. The front and back views 10a, 10b are perpendicular to the left and right side views 10c, 10d such that the views 10a, 10b, 10c, 10d of the multi-view composite image 10 form a right angled cross as shown in FIG. 4. The multi-view image 10 is loaded and rendered in real time by the processor.

In the next step, the multi-view image 10 is correctly oriented and projected onto the display structure 6 to produce a virtual 3D holographic image of the object 9. When the projector has a display screen (e.g. is a tablet or a smartphone), the display screen is aligned with the display structure 6 such that the front view 10a is projected onto the front face of the display structure 6, the back view 10b is projected onto the back face of the display structure 6, the left side view 10c is projected onto the left side face of the display structure 6, and the right side view 10d is projected onto the right side face of the display structure 6. The resulting virtual 3D holographic image of the object 9 can be seen from all sides of the display pyramid 6; therefore somebody viewing the virtual 3D holographic image from the front of the display structure 6 would see the front of the object, and as they walked clockwise around the display structure 106, the viewer would respectively see the right side, the back, the left side and then the front of the object. Utilizing the phenomena known as Pepper's Ghost Effect, these multiple views of the object appear to be “floating” in space when projected on the semi-transparent display pyramid surfaces, thus giving the viewer the impression of seeing a 3D hologram of the object inside the display structure 6. The Unity game engine or other 3D modelling software can be used to animate the 3D model of the object 9, thus causing the virtual cameras to capture 2D views of the moving object, and causing the projected images on the display structure 6 to also be moving such that the virtual 3D holographic image of the object also appears to be moving.

MS Middleware Platform

As noted, above, the middleware implementation program code is created using a human interface sensor middleware platform, which provides mechanisms for reporting and interrogating the protocols used by the sensors and actuators, as well as a standard architecture for creating services. More particularly, the middleware implementation program for controlling the virtual hologram machine 1 is created using a middleware platform that manages data provided by motion sensors (“Motion Sensor middleware platform”, or “MS middleware platform”). Although this description is in the context of the MS middleware platform, it is to be understood that the middleware platform can also be configured to manage input data from sensors other than motion sensors.

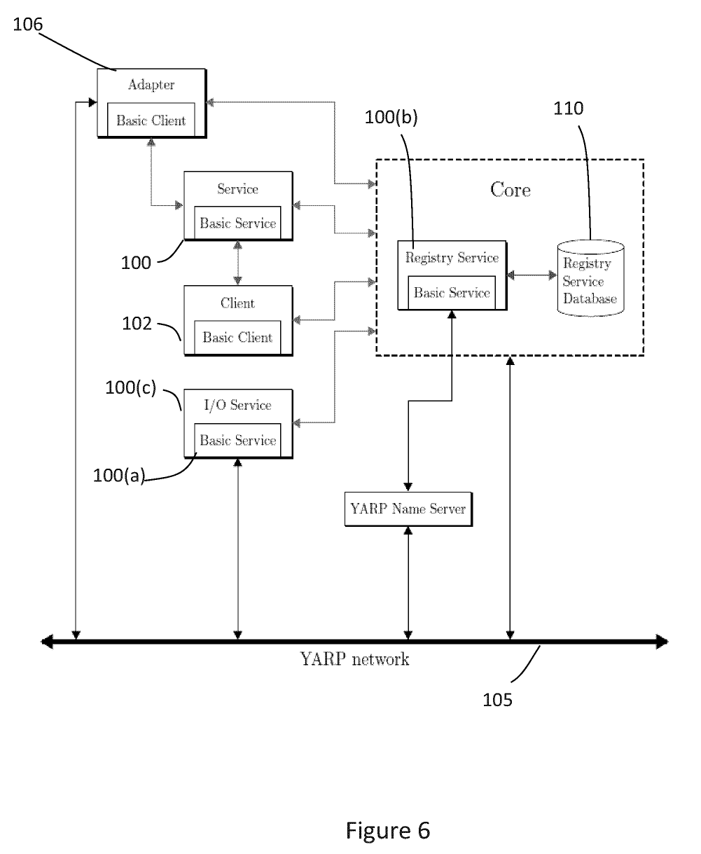

Referring to FIG. 6, the MS middleware platform comprises a set of program modules that interconnect using networking protocols based on the open source YARP platform, along with libraries that can be linked to applications to provide access to features offered by the MS middleware platform. The program modules comprise three main classes, namely: services 100, clients 102, and utilities 104 in communication with a YARP network 105.

Clients 102 use a formalized protocol to connect to the services 100.

Utilities 104 manage or monitor the aggregate state of a particular middleware implementation program. The utilities 104 include a channel manager utility, which provides a graphical user interface (GUI) view of the state of connections, services and clients within the middleware implementation program.

Services 100 are a collection of defined logical operations, which can be a single function or combination of several functions, that define either input/output or adapter properties. A service can be a class in C++ which contains both members and functions. Each service can support multiple client connections, and the client functionality can be embedded in command—line tools, GUI—based applications or headless background processes. Each service is like a bottle that each contains a logical operation for either an input mechanism or an output mechanism. Services that contain input mechanisms are called input services, wherein an input service is defined for a particular sensor; a known input service is KinectInputService, which contains logical operations for handling data input received from a Kinect™ sensor into the middleware implementation program. Similarly, output services contain output mechanisms, wherein an output service is defined for a particular actuator; an example of a known output service is UnityOutputService, which contains logical operations for handling data transmitted to a sensor into Unity Game Engine™ through the middleware implementation program.

The services 100 include basic services 100(a), simple services 100(b), and input/output services 100(c). The basic service 100(a) is a core middleware service which essentially is the backbone that forms connections between all the inputs and outputs of related services 100. The input/output services 100(c) provide a mechanism for packaging input devices (also known as “sensors”) and output devices (also known as “actuators”) as resources, and have one or more additional YARP network connections with specific protocols. The simple services 100(b) are input and output services 100(c) with simple one-to-one connections, i.e. has either one incoming or outgoing connection. An example of a simple service 100(b) is a registry service, which is a server that runs on YARP and maintains information on all active services that are accessible to the clients within an MS middleware implementation. The registry service 100(b) stores the information on an internal registry service database 110, which stores all the data coming from the input services 100(b) and enables users who to analyse this data. As noted above, simple services such as the registry service 100(b) have one or more additional YARP network connections that have no special properties.

The MS middleware platform further includes adapters 106 which provide a mechanism for non-motion sensor middleware applications to make requests of services of the MS middleware implementation via the YARP network connections 105. Basic clients 102 have only the client/service YARP network connection while adapters 106 have one or more additional YARP network connections 105.

Utilities

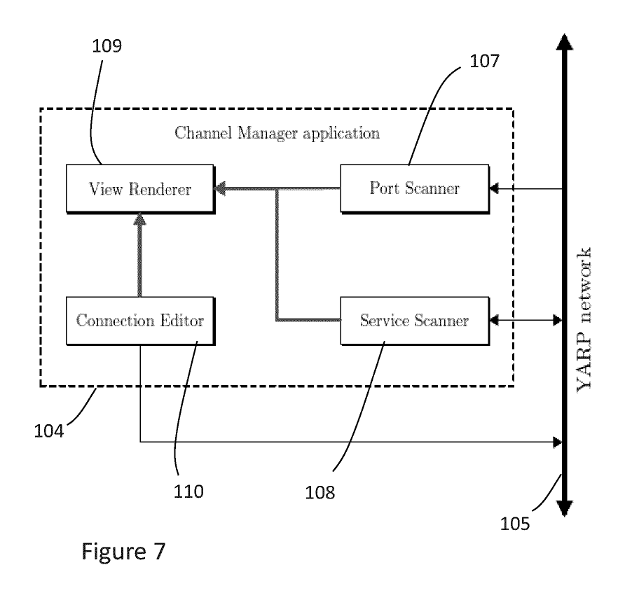

Referring now to FIG. 7, utilities 104 are program modules that provide access to the processes that are running in the middleware installation. One of the utilities is Channel Manager 104, which is a GUI—based tool that provides a programmer with a view of the state of connections within the middleware implementation as well as a means for managing non—M+M YARP network connections. The Channel Manager 104 application comprises a port scanner 107 and a service scanner 108 each communicative with the YARP network 105, a view renderer 109 communicative with the port scanner 107 and service scanner 108, and a connection editor 110 communicative with the view renderer 109 and the YARP network 105. The port scanner 107 is a program which scans for active connections/services from the middleware server and fetches ports for every connection and reports back to the view renderer 110. The service scanner 108 is a class that contains port information and addresses on which data is supposed to be communicated. The connection editor 110 is an application in which a set of YARP functions can applied, such as connecting and disconnecting two services. The view renderer 109 is a program which renders a view of all the middleware connections with its address name and port information.

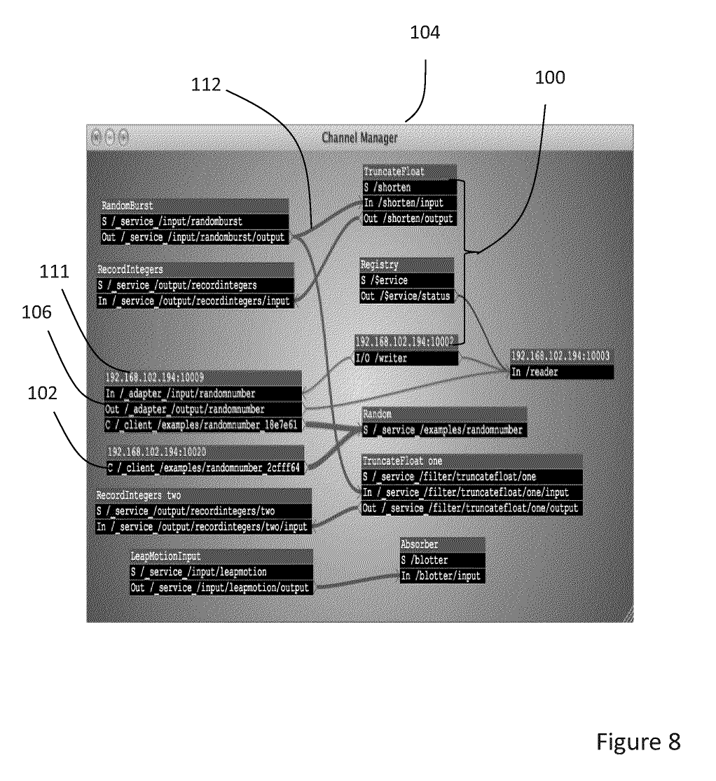

An example of a rendered view by the Channel Manager utility is shown in FIG. 8. In operation, the Channel Manager utility 104 has a graphical user interface (GUI) which displays a single window view of the connections within the YARP network 105, with features designed to make management of the middleware implementation easier. In one embodiment, simple YARP network ports 111 are shown in the GUI as rectangles with a title consisting of the IP address and port number of the port, and the YARP name for the port as the body of the rectangle, prefixed with ‘In’ for input-only ports, ‘Out’ for output—only ports and ‘I/O’ for general ports. Services are shown as rectangles with a title consisting of the name provided by the service, with the primary YARP network connection as the first row in the body of the rectangle, prefixed with ‘S’ to indicate that it is a service connection. Secondary YARP network connections appear as rows below the primary connection, prefixed with ‘In’ for input-only connections and ‘Out’ for output—only connections. Input/Output services do not have a visual appearance that is distinct from other services—the connections that are allowed, however, are more restricted. Both services and clients of the MS middleware can have multiple secondary YARP network ports.

Simple clients 102 are shown as rectangles with a title consisting of the IP address and port number of their connection to a service, with a row containing the YARP network connection prefixed with ‘C’. Adapters 106 are similar to the simple clients 102, except that they have additional rows above the client-service YARP network connection for the secondary YARP network connections, with prefixes of ‘In’ for input-only connections and ‘Out’ for output-only connections.

Connections 112 between ports are shown as lines with differing thicknesses and colours. For example, one set of lines can show YARP network connections, which have no explicit behaviours. Another set of lines can represent connections between Input/Output services; these connections have specific behaviours. Another set of lines represent connections between clients and services, which are not modifiable by this tool. Connections that can be created include TCP/IP or UDP connections. The Channel Manager utility allows a user to create connections between two ports or remove connections between two ports.

Other utilities provided by the MS middleware platform include the following:
Repaint: force a repaint, in case there's a ‘glitch’ of the display;
Invert background: invert the background;
White background: switch between a black/white background and a gradient;
Display service information: display information about a selected service
Display detailed service information: display information about a selected service, including the (non-default) requests for the service
Display service metrics: display information about the activity on each port of a selected service—the number of bytes and number of messages sent to and from the port, including the anonymous ports used by the service during its operation
Display channel information: display information about a selected channel
Display detailed channel information: generate output in tab-delimited form
Display channel metrics: display information about the activity on a selected channel—the number of bytes and number of messages sent to and from the channel msClientList: This utility displays the clients for services that have YARP network connections with persistent state. A service that has persistent state for its connections retains information from each request for the following request. An example service with persistent state is msRunningSumService, where the information that is kept is the running sum for the connected client. The program takes an optional argument for the YARP network port of the service; if no argument is provided, all services are checked for connections with persistent state. The output specifies the YARP network port of a service with persistent state and the YARP network ports that are connected to it.

msFindServices: This utility displays the primary channels belonging to services that match a criteria provided on the command-line or interactively.

msPortLister: This utility displays the active YARP ports and MS entities. For each YARP port, its role in the middleware installation is shown as well as any incoming and outgoing YARP network connections. The primary port for each active service is identified, as well as the primary port for each adapter. The output specifies the all the active YARP network ports along with their input and output YARP network ports; regular YARP network ports are tagged as ‘Standard’, while MS adapter ports are tagged as ‘Adapter’, MS client ports are tagged as ‘Client’ and MS service ports are tagged as ‘Service’ or ‘Service registry’. ‘Standard’ ports report their IP address and network port while ‘Adapter’ ports report the MS port of their client application, ‘Client’ ports report their attached ‘Adapter’ ports, if any are present and ‘Service’ ports report the name of the MS service that they provide. The connections indicate their direction relative to the YARP network port that is being listed, along with the YARP network port that is being connected to and the mode of the connection, such as TCP or UDP.

msRequestInfo: This utility displays information on requests for one or more active services in the middleware implementation. It lists each request, along with the YARP network port for the service that handles the request and details about the request. The program takes two optional arguments for the YARP network port of the service and the request to get information on; if the request is not specified, all requests for the given service are shown and, if no port is specified, all requests for all services are displayed. The output consists of the YARP network port that is used by the service, the name of the request, its version number, a description of the request, including its expected input and expected output, as well as alternate names for the request and the format of its inputs and outputs.

msServiceLister: This utility displays the active services in the middleware implementation. It lists each service, along with the service description and requests, as well as the path to the executable for the service and the YARP network ports that the service provides. The output consists of the YARP network port for the service, the ‘canonical’ name of the service, the kind of service (‘Filter’, ‘Input’, ‘Output’, ‘Normal’ or ‘Registry’), a short description of the service, a short description of the requests supported by the service, the path to the executable for the service and any secondary input or output YARP network ports attached to the service.

msServiceMetrics: This utility displays measurements for the channels of one or more active services in the middleware implementation. It lists each YARP network port for the service and details about the activity on the channel. The program takes an optional argument for the YARP network port of the service; if no port is specified, all services are displayed. The output consists of the YARP network port that has been measured, the date and time of the measurement, the number of input and output bytes transferred and the number of input and output transfers. The primary YARP network port for the service as well as its secondary ports are reported, along with an entry labelled ‘auxiliary’, which represents any transient YARP network ports that the service has used.

msVersion: This utility displays the version numbers for MS, YARP and ACE, the low-level networking layer used by MS and YARP.

msRequestCounterService: This application is a background service that is used to determine the average time to send a simple request, process it and return a response. It responds to the resetcounter and stats requests sent by the companion application msRequestCounterClient to manage the statistics that it gathers.

msRequestCounterClient: This application is a command-line tool to measure the average time to process a simple request. It uses the resetcounter and stats requests sent to the msRequestCounterService application to gather the statistics, and a ‘dummy’ request to provide the requests that are being measured.

Services and Their Protocols

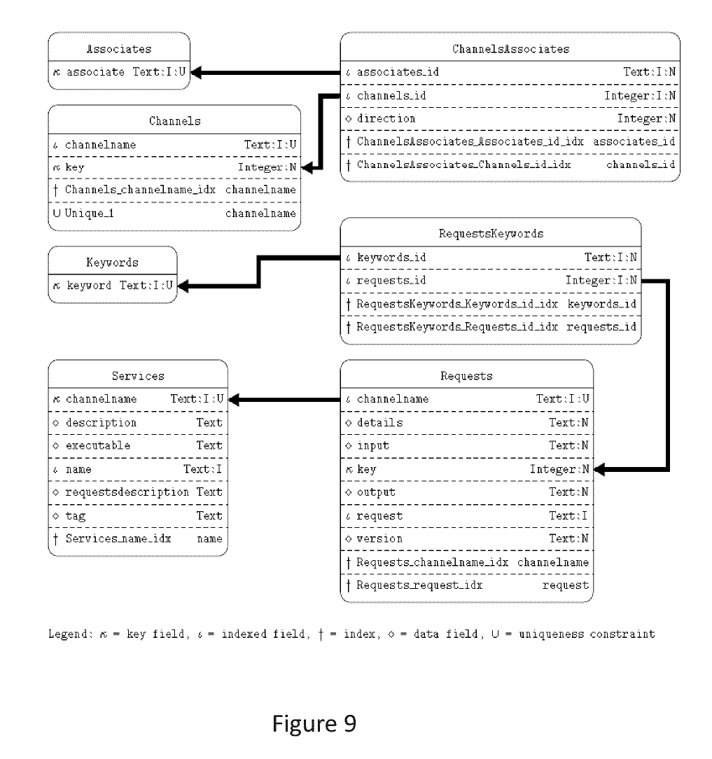

The middleware platform provides a number of service 100 applications and their companion client applications 102, communicating via MS requests and responses on the YARP network 105. One special service, the Registry Service 100(b), is an application which manages information about all other active services; all services register themselves with the Registry Service 100(b) so that client 102 applications and utilities 104 can get information about the service 100. The Registry Service 100(b) is a background application that is used to manage other services 100 and their connections. Its primary purpose is to serve as a repository of information on the active services in the middleware implementation. The registry service 100(b) stores the information on the internal database 110 and responds to the requests in a Registry Service Requests group. The database structure is shown in FIG. 9, and the following SQL statements can be used to construct the internal database 110:

```
CREATE TABLE IF NOT EXISTS Services(
    channelname Text NOT NULL DEFAULT PRIMARY KEY
    ON CONFLICT
    REPLACE,
    name Text NOT NULL DEFAULT _,
    description Text NOT NULL DEFAULT _,
    executable Text NOT NULL DEFAULT _,
    requestsdescription Text NOT NULL DEFAULT _,
    tag Text NOT NULL DEFAULT _);
CREATE INDEX IF NOT EXISTS Services_name_idx ON
Services(name);
CREATE TABLE IF NOT EXISTS Keywords(
    keyword Text NOT NULL DEFAULT _ PRIMARY KEY
ON CONFLICT IGNORE;
CREATE TABLE IF NOT EXISTS Requests(
    channelname Text NOT NULL DEFAULT _ REFERENCES
    Services(channelname),
    request Text NOT NULL DEFAULT _,
    input Text,
    output Text,
    version Text,
    details Text,
    key Integer PRIMARY KEY);
CREATE INDEX IF NOT EXISTS Requests_request_idx_ON
Requests(request);
CREATE INDEX IF NOT EXISTS Requests channelname_idx ON
Requests(channelname);
CREATE TABLE IF NOT EXISTS RequestsKeywords(
    Keywords_id Text REFERENCES Keywords(keyword),
    requests_id Integer REFERENCES Requests(key));
CREATE INDEX IF NOT EXISTS
RequestsKeywords_Keywords_id_idx ON
    RequestsKeywords(keywords id);
CREATE INDEX IF NOT EXISTS
RequestsKeywords_Requests_id_idx ON
    RequestsKeywords(requests_id);
CREATE TABLE IF NOT EXISTS Channels(
    channelname Text NOT NULL UNIQUE DEFAULT _,
    key Integer PRIMARY KEY);
CREATE INDEX IF NOT EXISTS Channels_channelname_idx ON
Channels(channelname);
CREATE TABLE IF NOT EXISTS Associates(
    associate Text NOT NULL DEFAULT _ PRIMARY KEY
ON CONFLICT IGNORE);
CREATE TABLE IF NOT EXISTS ChannelsAssociates(
    Channels_id Integer REFERENCES Channels(key),
    Associates_id Text REFERENCES Associates(associate),
    direction Integer);
CREATE INDEX IF NOT EXISTS
ChannelsAssociates_Associates_id_idx ON
    ChannelsAssociates(associates_id);
CREATE INDEX IF NOT EXISTS ChannelsAssociates Channels id idx
ON
    ChannelsAssociates(channels_id);
```

Other services can be broadly characterized as either Input/Output services 100(c) or basic services 100(a) The Input/Output services 100(c) can be further divided into Input services, Output services and Filter services. Input services act as intermediaries between external data sources and the middleware implementation infrastructure.

Output services act as intermediaries between the middleware implementation and the actuators. Filter services act as translators between data formats.

The services 100 receive requests from clients 102. When a client 102 sends a request to a service 100, the client 102 can optionally request a response from the service 100. If no response is requested, the request is processed but no response is sent. The requests can be categorized into the following four categories:
Basic Requests: requests that support the fundamental middleware implementation service mechanisms. Basic Requests are part of every service and automatically supported in a base class of all services, known as BaseService. They constitute the fundamental mechanism that is used by the Registry Service to identify each active service.
Registry Service Requests: requests that are specific to the Registry Service 100(b). The requests in this group are used exclusively by the Registry Service application 100(b) to manage its internal database and to respond to information requests from client applications 102.
Input/Output Requests: requests that are specific to the Input/Output services 100(c). The Input/Output services 100(c) have secondary YARP ports that provide access to the information that they process in response to the input/output requests. Input services have one or more secondary output YARP network ports, Output services have one or more secondary input YARP network ports and Filter services have both secondary input and output YARP network ports. An Input service can also have secondary output YARP network ports and an Output service can also have secondary input YARP network ports. All services and clients utilize a request/response protocol that is defined by the M+M C++ core classes.

Program Modules for Handling Motion Sensor Inputs

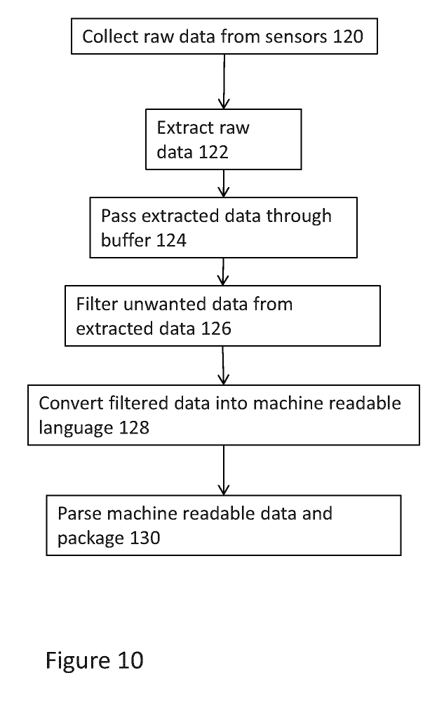

FIG. 10 illustrates a flow chart of the steps performed by program modules of the MS middleware platform that process raw data acquired from a motion sensor such as the motion capture camera 2, and to package this data into a user friendly form that a programmer can use to develop a middleware implementation to control an interactive machine such as the virtual hologram machine 1. The program modules form the middleware implementation, and are essentially application programs derived from the input/output services 100 of the MS middleware platform. The utilities and client services 102, 104 are available for use with the program modules, and provide access to the processes that are running in the middleware installation. For example, the Channel Manager 104 utility provides a view of the state of connections within the program modules of the middleware implementation.

The steps performed by the program modules will be described in the context of an example wherein the camera 2 and microphone 3 are part of a Microsoft Kinect™ sensor (not shown) which captures and converts a person's body motions into digitized skeleton data (video input data) and the person's speech into digitized audio data (audio input data).

First, raw data is collected by the input module from the drivers of the sensors (step 120); for example, the Kinect for Windows™ software development kit 2.0 (SDK) can be used to provide the Kinect™ drivers and APIs for the middleware platform to collect the raw data in the form of processed depth and body video input data (commonly referred to as a full body skeleton) and digitized audio data. In this example, the input service 100 KintectInputSerice is used in the input module.

The collected raw data is then transmitted to the middleware module and is extracted (step 122); extraction can include selecting only the parts of the data that are relevant for one or more specified intended uses (herein referred to as “feature extracted data”). For example, the raw skeleton and audio data acquired from the Kinect™ device can be transported over the UDP/TCP network using the address and port information provided by the YARP platform, and then extracted to produce different feature extracted data, such as velocity data and acceleration data (e.g. by differentiating distance data over time, and differentiating velocity data over time). These velocity and acceleration data can be used by the middleware implementation to control certain operations of the virtual hologram machine 1, such as changing the view of the displayed object.

The feature-extracted data is then passed through one or more buffers (step 124). The buffers act like a temporary bus for the extracted raw data to be transferred to the filter module. Parallel buffers can be used when there are multiple input devices (sensors), with one buffer dedicated to each input device (sensor). A latency and correction check can be performed in this step, comprising applying a zero point check and smoothing algorithms in order to ensure that meaningful data is transmitted via the MS middleware implementation. Zero point check essentially checks for zero crossing of data when it is not expected. If this unexpected behaviour is noticed, the region around the zero crossing is stripped off from communication protocols.

Next, the filter module applies signal processing to the feature extracted data (step 126) to filter unwanted data. The filter module comprises signal-processing algorithms, which can be discretely and/or continuously applied, depending on a user's defined parameters. The types of signal processing algorithms that are used will depend in part on the type of sensors used and the nature of the raw data acquired by these sensors. Known video processing algorithms that use video filters can be applied to improve the quality of the video input data captured by the camera; such signal processing are known in the art and thus not discussed in detail here. For example, smoothing algorithms such as Kalman filtering can be used to remove the noise and jitter from the feature extracted data so that more meaningful data is acquired from any given motion sensor. For example, when acquiring velocity of x axis from motion of the right hand, there normally is a lot of noise and Kalman filtering being a light weight algorithm can be applied in real time to produce more meaningful data.

The user can selectively define what signal processing operations are to be performed. For example, the Kinect™ can detect hand-clapping sounds, and represent clapping sounds as integer values, and silence as zeros; when a user wishes to reduce the delay in detection (i.e. reduce latency), the filter module can be configured to remove the zeros between integer values.

Once the feature extracted data has been filtered, the filtered data is then passed to a reconstruction module wherein the filtered data is converted into an array or sequence of numbers that are in a higher level machine readable form (step 128). For example, an effector service is provided which structures the skeleton data into a hierarchical form according to a 3D sensor protocol, so that the data can be systemically queried and relevant information can be easily acquired on the effector end by the middleware implementation to carry out one or more operations. The effector service decodes the sensor data in a manner required by the operation that uses the data; for example, if the middleware implementation is programmed with an operation that enables a user to manipulate the position of the digitized object according to the horizontal (x) position of the user's right hand, the effector service is programmed to decode the skeleton data pertaining to x position of the right hand. Furthermore the debugging can also be done in real-time in order to understand on what address is a particular data being communicated.

The converted data is then sent to a communications module, where the data is checked off and parsed into data packages (step 130). The checked off data is essentially filtered data, wherein noise in the raw input data has been filtered (e.g. using the Kalman low pass filter) to produce smoother data with less noise in any given frame of an application. Data that qualifies as checked off data can be predefined in the MS middleware platform or be user defined. The checked off data is stored in a YARP bottle and sent through the MS middleware platform. The YARP bottle is essentially a container where all the data that needs to be transmitted over the MS middleware platform is stored. This is the place where the MS middleware platform provides standard motion sensors protocols as well as an ability to configure protocols in real-time. The data packages are then sent to selected output modules for access by the middleware implementation to perform the associated higher-level function. For example, the x position of the right hand of the skeleton is sent via the UDP/TCP network as a data package that can be used by the middleware implementation to change the position of the digitized object.

While particular embodiments have been described in this description, it is to be understood that other embodiments are possible and that the invention is not limited to the described embodiments and instead are defined by the claims. For example, the middleware platform can be used to create program modules used to develop middleware implementations other than controlling an interactive virtual hologram display machine. For example, a middleware implementation can be provided for a holographic teleconferencing system, that can stream real time Depth information (3D data) of a first user captured using a 3D video camera in a first location, to an interactive virtual hologram display machine in a second location, which can then display the first user to a second user in the second location.

In another example, a middleware implementation is provided to enable the interactive virtual hologram display machine to be controlled by a brain wave sensing device, e.g. an EEG sensor. The EEG sensor is attached to a user's head, and the user's brian waves are read in real time and then communicated to the interactive virtual hologram display machine via the middleware implementation.

In another example, a middleware implementation is provided to enable the interactive virtual hologram display machine to be controlled by a 3D image sensor attached to a tablet computer, such as an iPad™, such that an object captured by the 3D image sensor can be displayed by the interactive virtual hologram display machine. Once the 3D image data is captured, a 3D digital model is rendered and then exported into the interactive virtual hologram display machine, and the model can be manipulated and viewed from different angles using the tablet computer. The middleware implementation can be further configured to transfer the 3D model from the interactive virtual hologram display machine to a 3D printer to be printed.

In another example, a middleware implementation is provided to enable the interactive virtual hologram display machine to be controlled by a mobile communication device, such as a wirelessly connected smartphone. Once the smartphone is paired with the interactive virtual hologram display machine, information can be transferred to the interactive virtual hologram display machine in order to manipulate content displayed in the interactive virtual hologram display machine in real time.

In another example, a middleware implementation is provided wherein the output device are a series of projectors that project images onto a wall. The input device can a smartphone such as an iPhone.

What is claimed is:

1. A computer readable medium having encoded thereon a middleware platform program executable by a processor to create a middleware implementation for controlling at least one sensor and at least one actuator in a human interactive machine, the middleware platform program comprising:
(a) at least one input module, each input module configured to acquire raw data from a human interface sensor;
(b) a middleware module configured to extract feature extracted data from the raw data, the feature extracted data being relevant input data for controlling an operation of the human interactive machine by the middleware implementation;
(c) a filter module configured to apply signal processing operations to the feature extracted data; and
(d) a reconstruction module configured to convert the filtered feature extracted data into a converted form accessible by a programmer to create the middleware implementation.

2. A computer readable medium as claimed in claim 1 wherein the human interface sensor is a motion capture camera.

3. A computer readable medium as claimed in claim 2 wherein the raw data is a full body skeleton data and the feature extracted data is a portion of the full body skeleton data.

4. A computer readable medium as claimed in claim 3 wherein the converted form of the portion of the skeleton data is hierarchal data according to a selected 3D sensor protocol.

5. A computer readable medium as claimed in claim 1 wherein the input, middleware, filter and reconstruction modules are program modules that interconnect using networking protocols based on a YARP programming platform (“YARP network”).

6. A computer readable medium as claimed in claim 5 wherein the middleware platform program further comprises at least one utility program communicative with at least one of the program modules, and comprising program code executable to monitor and control processes running in the at least one of the program modules.

7. A computer readable medium as claimed in claim 6 wherein the utility program is a channel manager program communicative with the YARP network and executable to monitor services and connections between services in the at least one of the program modules, and to apply a set of YARP functions to the services.

8. A computer readable medium as claimed in claim 7 wherein the channel manager program comprises a view renderer which when executed renders a view of the services and connections of the at least one of the program modules, including an IP address, a port number, and a name of each service.

9. A computer readable medium as claimed in claim 5 wherein the middleware platform program further comprises a registry service program communicative with other service programs in the program modules, and comprises a registry database which stores information about the other service programs.

10. A method for creating a middleware implementation executable by a computer, and for controlling at least one sensor and at least one actuator in a human interactive machine, the method comprising
(a) acquiring raw data from a human interface sensor of the human interactive machine;
(b) extracting feature extracted data from the raw data, the feature extracted data being relevant input data for controlling an operation of the human interactive machine by the middleware implementation;
(c) filtering the feature extracted data by applying signal processing operations to the feature extracted data; and
(d) converting the filtered feature extracted data into a converted form accessible by a programmer to create the middleware implementation.

11. A method as claimed in claim 10 wherein the feature extracted data is passed through one or more buffers before filtering the feature extracted data.

12. A method as claimed in claim 11 wherein a latency and correction check is performed on the feature extracted data while passing through the one or more buffers.

13. A method as claimed in claims 10 wherein filtering the feature extracted data comprises applying Kalman filtering to the feature extracted data.

14. A method as claimed in claim 10, wherein the step of converting the filtered feature extracted data comprises checking off and parsing the filtered feature extracted data into checked-off data packages.

15. A method as claimed in claim 14, wherein data is transported through the middleware implementation using networking protocols based on a YARP programming platform (“YARP network”), and checked-off data packages is stored in a YARP bottle and transported via the YARP network to at least one output module for performing the operation of the human interactive machine.

16. A method as claimed in claim 11 wherein filtering the feature extracted data comprises applying Kalman filtering to the feature extracted data.

17. A method as claimed in claim 12 wherein filtering the feature extracted data comprises applying Kalman filtering to the feature extracted data.

18. A method as claimed in claim 11, wherein the step of converting the filtered feature extracted data comprises checking off and parsing the filtered feature extracted data into checked-off data packages.

19. A method as claimed in claim 12, wherein the step of converting the filtered feature extracted data comprises checking off and parsing the filtered feature extracted data into checked-off data packages.

20. A method as claimed in claim 13, wherein the step of converting the filtered feature extracted data comprises checking off and parsing the filtered feature extracted data into checked-off data packages.
